(19) United States
(12) Patent Application Publication
(10) Pub. No.: US 2018/0037048 A1
(43) Pub. Date: Feb. 8, 2018

(54) Bottle Card

(71) Applicants: Joseph Kight, New Orleans, LA (US); Stephanie Reed, New Orleans, LA (US)

(72) Inventors: Joseph Kight, New Orleans, LA (US); Stephanie Reed, New Orleans, LA (US)

(21) Appl. No.: 15/404,300

(22) Filed: Jan. 12, 2017

Related U.S. Application Data
(60) Provisional application No. 62/371,715, filed on Aug. 6, 2016.

(51) Int. Cl. B42D 15/02; B42D 15/04; G09F 1/04; B65D 23/14; B65D 1/02

(52) U.S. Cl. CPC B42D 15/022; B65D 23/14; B65D 1/02; G09F 1/04; B42D 15/042

(57) ABSTRACT

This invention is a bottle-mounted greeting card upon which graphics and/or text may be displayed for viewing. The card is comprised of integrated bottle flaps that enable adhesion and/or attachment by means to a cylindrical form and 2) the creation of an central window within the confines of the greeting card through which the label of the bottle becomes viewable when the greeting card is attached to the bottle, when otherwise the label on the bottle would be hidden or rendered out of view without said central window.

### CROSS REFERENCE TO RELATED APPLICATIONS

This application is a continuation in part of USPTO application No. 62/371,715 filed on Aug. 6, 2016.

### REFERENCE TO GOVERNMENT FUNDING SOURCES

Not applicable.

### REFERENCE TO SEQUENCE LISTING

Not applicable.

### FIELDS OF THE INVENTION

This invention is thought to be in field of gift giving. More particularly, in the field of greeting cards. More particularly, in the field of greeting card attachments.

### DESCRIPTION OF RELATED ART

The present invention relates to greeting cards. In particular, the present invention relates to greeting cards that, by design, are attachable to cylindrical forms. Typically, when a person offers a gift to another of wine, champagne, beer, or other material packaged in a bottle, the giving individual seeks a way to personalize the gift by accompanying the gift bottle with a greeting card, a decorative form-fitted bag, a ribbon tied to the bottle, or other method of personalization of the bottle gift. The present invention expands options for the gift bottle giver(s) to personalize the gift bottle.

There is a need in the art for an apparatus that enables attachment of a greeting card to cylindrical objects such as bottles of wine, champagne, beer, potable liquids, olive oils, fine vinegars, fine condiments, and/or other materials packaged in bottles and/or cylindrical forms and offered as gifts from one person or group to another person or group.

### GENERAL SUMMARY OF THE INVENTION

In the preferred embodiment, the invention is a bottle-mounted greeting card comprising a card upon which graphics and/or text may be displayed for viewing, with the intention of the graphics being the personalization of a gift bottle through a humorous, nostalgic, puzzling, and/or emotional sentiment, or other sentiment, that communicates friendship and/or carries an appeal for the gift giver(s) and/or receiver(s) of the gift.

In another embodiment, the present invention contains a cut-out within the confines of the greeting card that serves at least two distinct purposes: 1) the creation of integrated bottle flaps that enable adhesion and/or attachment by means to a cylindrical form; and 2) the creation of an central window within the confines of the greeting card through which the label of the bottle becomes viewable when the greeting card is attached to the bottle, when otherwise the label on the bottle would be hidden or rendered out of view without said central window.

In another embodiment, the present invention contains folds in the compositional material of the greeting card that are exploited, by design, to enable by mechanical means the suspension of additional elements to the greeting card that move into multi-planar space with the activation by unfolding, or “opening,” of the greeting card, thus providing a dynamic, moving “lift” to various, additional elements of the greeting card.

In another embodiment of the present invention, there is a method for attaching a bottle greeting card to a bottle, comprising the placement of the greeting card onto the face of the bottle by means of adhesives to adhesion regions, thus covering the face of the bottle at a point desirable to the user, (typically the label midline) though by design and with the intention of rendering the label of the bottle, should there be a label, initially out of view but later revealed by the recipient of the gift bottle.

In another embodiment of the present invention, the greeting card may be designed and constructed such to contain additional adornments or pop ups such as: sound effects, recordable voice messages, light emitting diodes, and/or other features achievable through the use of discrete electronic devices which provide these features. Such devices are currently in general use within the greeting card industry, but the greeting card may contain electronic devices yet undiscovered, or those as yet not applied for use within greeting cards.

Such devices are embedded by means currently available and generally practiced during fabrication of greeting cards, but may be embedded within the greeting card by means not yet discovered and/or by means as yet not applied. These devices are activated by the unfolding of the greeting card, handling of the greeting card, lifting of the greeting card from a surface, change of ambient temperature of air surrounding the device embedded within the greeting card, radio signaling of the device, or other means of activation of the electronic device. These devices and the features they provide, when integrated within the greeting card, are intended to augment the personalization options of the card giver and enhance the enjoyment experienced by the individual or group who receive the greeting card. This intimate personalization achievable through electronic devices and means may expand the sentimental value experience and/or distinct personalization of the bottle gift while remaining consistent with the spirit and scope of the present invention.

Still other embodiments of the present invention will become apparent to those skilled in the art as detailed descriptions are provided which describe illustrative embodiments of this invention. This invention is capable of modifications that do not depart from the spirit and scope of the present invention. Drawings and descriptions are to be understood as illustrative in nature and not at all restrictive.

### DESCRIPTION OF FIGURES

FIG. 1 is a top partial diagram view which shows overall use of the device.

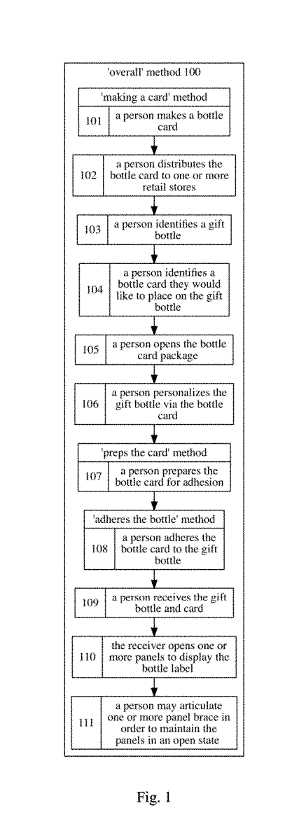

FIG. 2 is a top partial diagram view which shows the method of making a card.

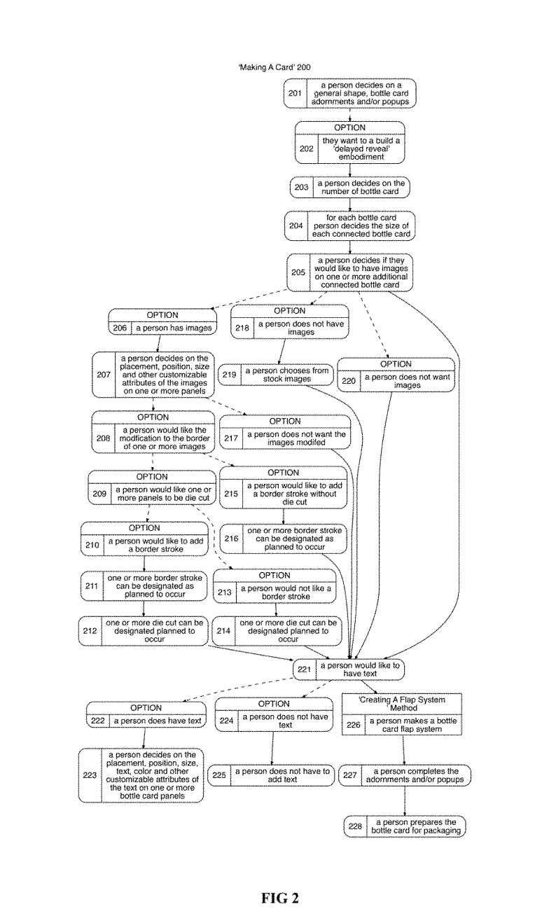

FIG. 3 is a top partial diagram view which shows the method of creating a flap system.

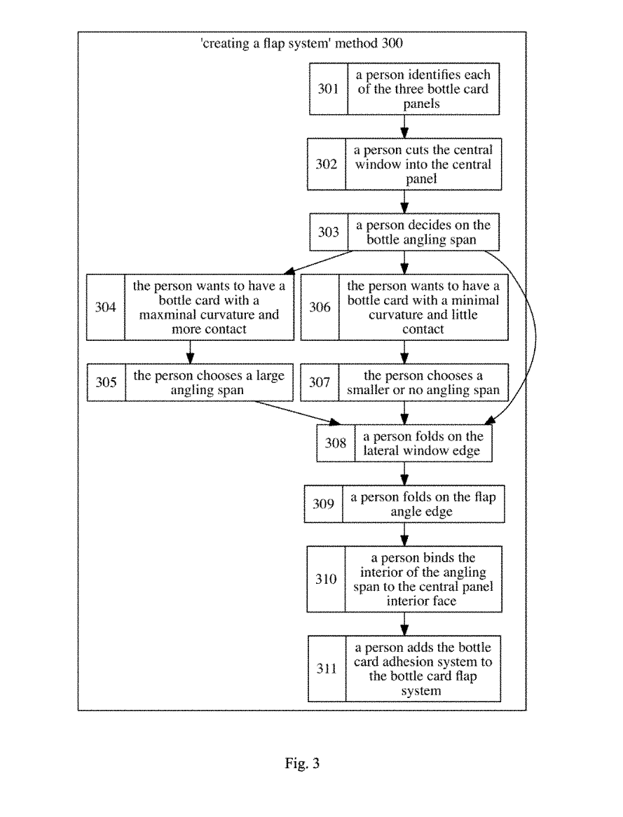

FIG. 4 is a top partial diagram view which shows the method of prepping a card.

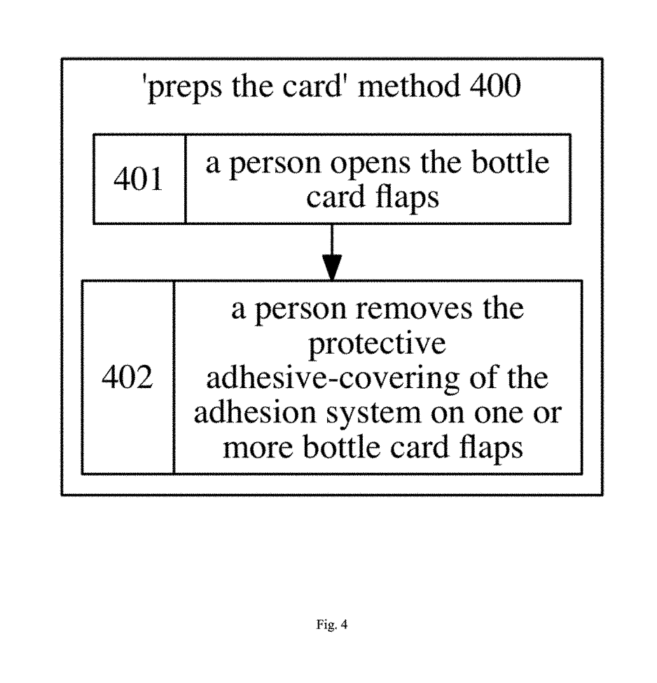

FIG. 5 is a top partial diagram view which shows the method of adhering the bottle to the card.

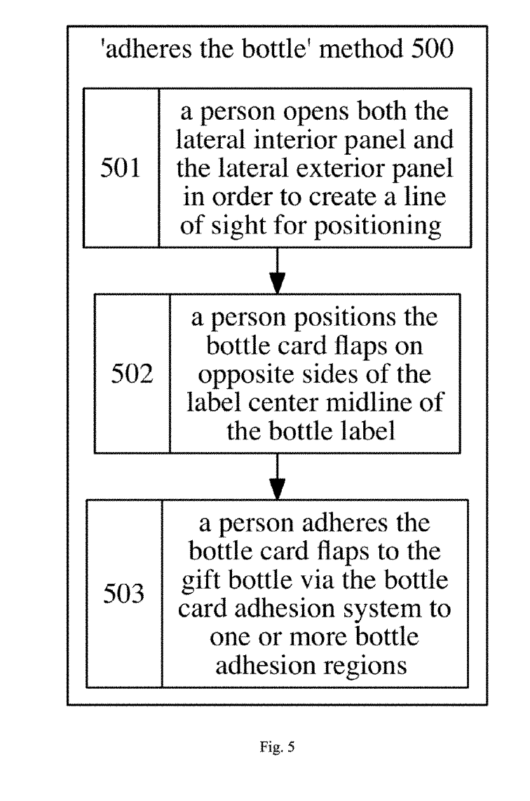

FIG. 6 is a perspective view which shows the back of a folded bottle card.

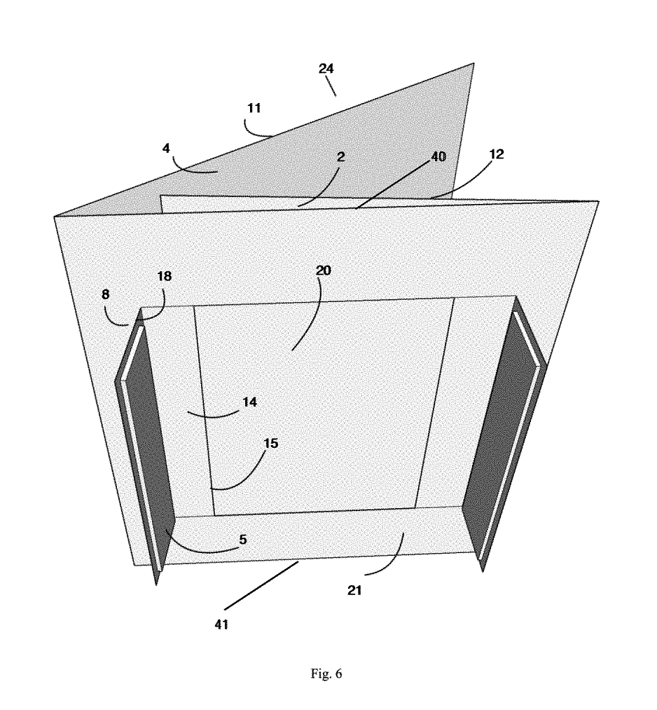

FIG. 7 is a perspective view which shows the side of a folded bottle card.

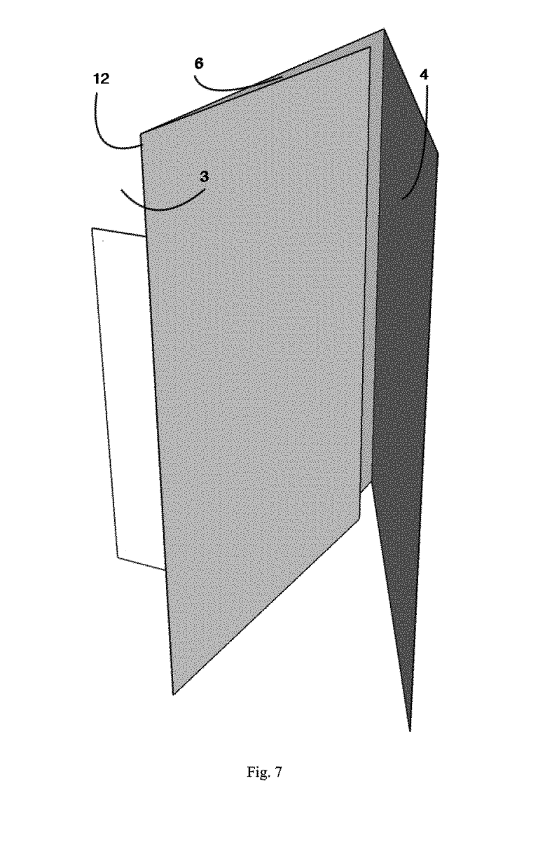

FIG. 8 is a perspective view which shows the front of an unfolded bottle card.

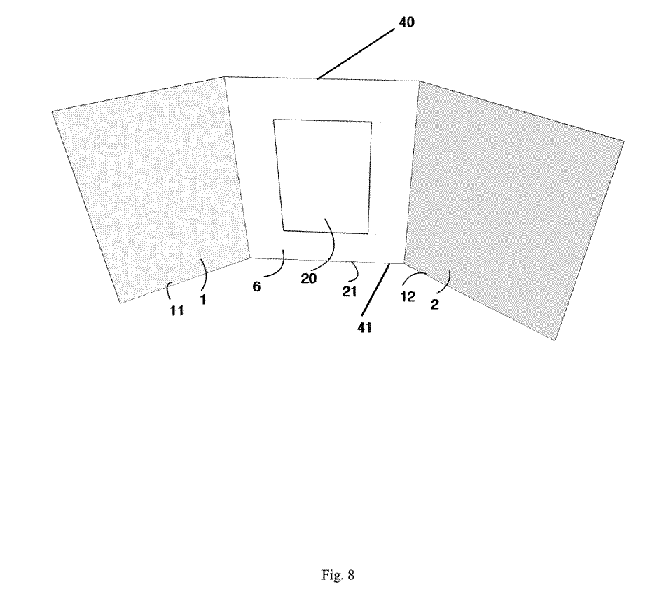

FIG. 9 is a perspective view which shows the back of an unfolded bottle card.

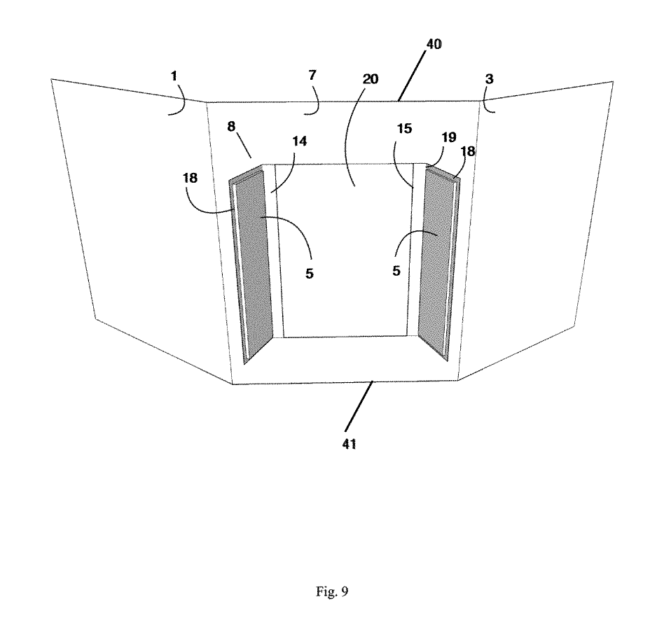

FIG. 10 is a perspective view which shows the front of a folded bottle card and gift bottle.

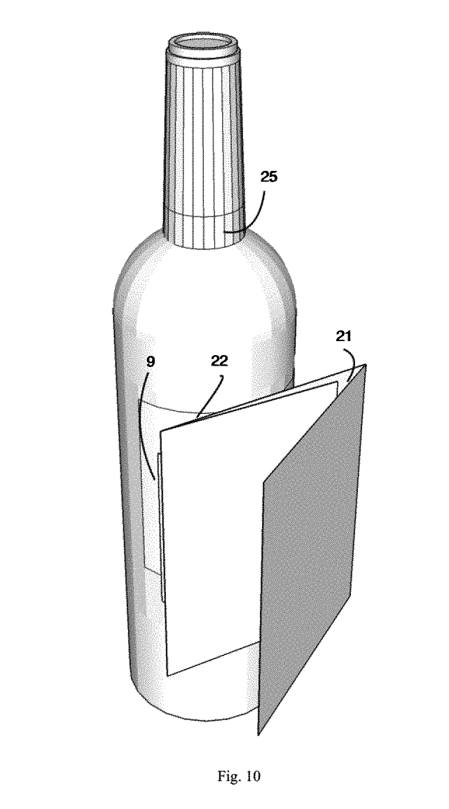

FIG. 11 is a perspective view which shows the front of an opened bottle card with panel braces on a gift bottle.

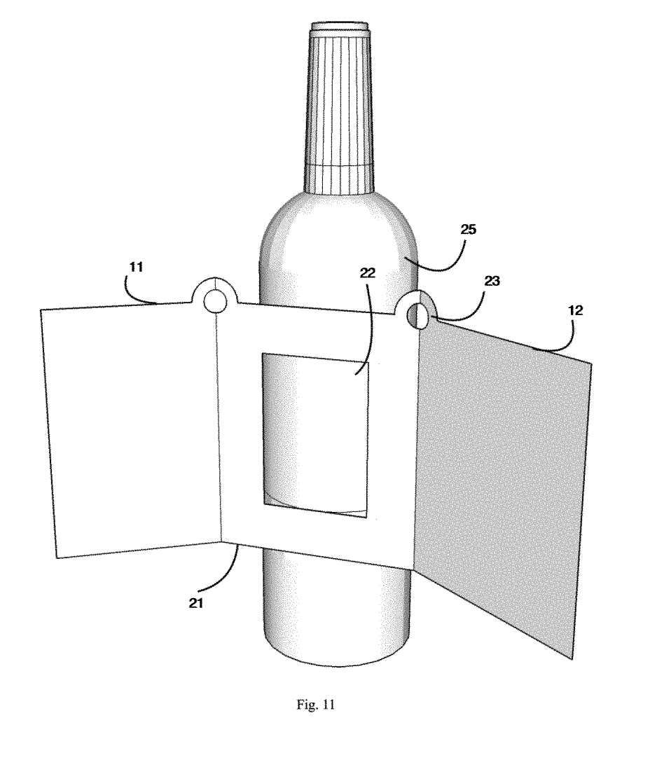

FIG. 12 is a perspective view which shows the side of an opened bottle card with panel braces on a gift bottle.

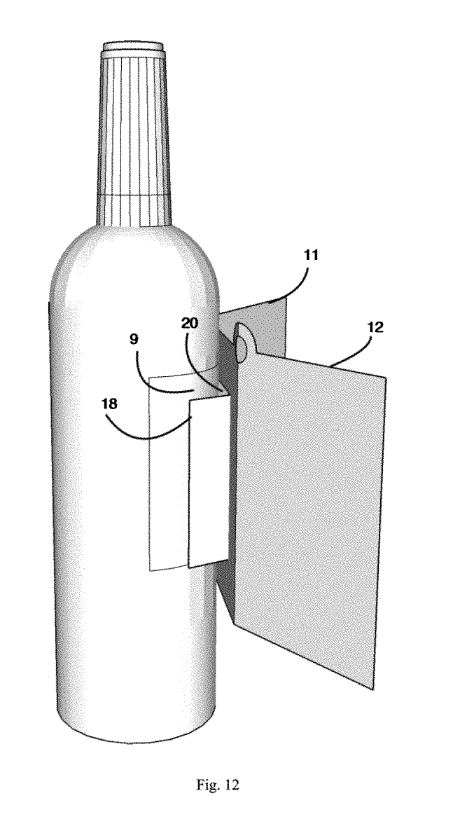

FIG. 13 is a perspective view which shows the front of an opened bottle card with a central panel display curve on a gift bottle.

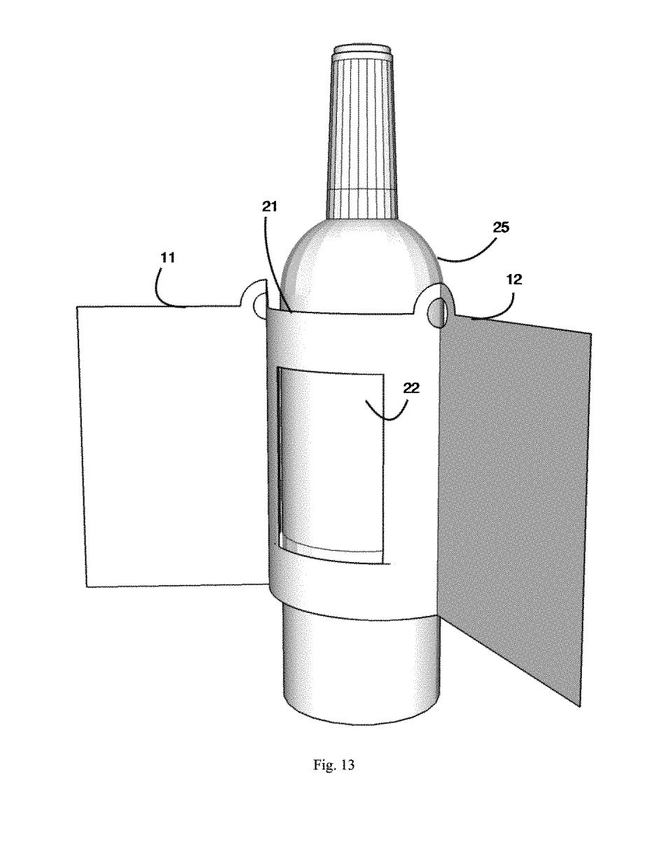

FIG. 14 is a perspective view which shows the side of an opened bottle card with a central panel display curve on a gift bottle.

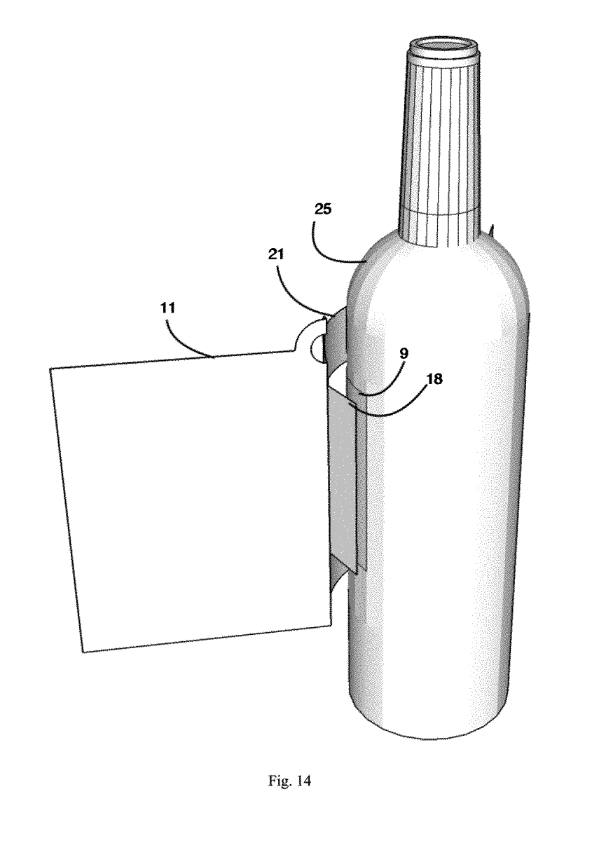

FIG. 15 is a perspective view which shows the front of a folded bottle card with a central panel display curve on a gift bottle.

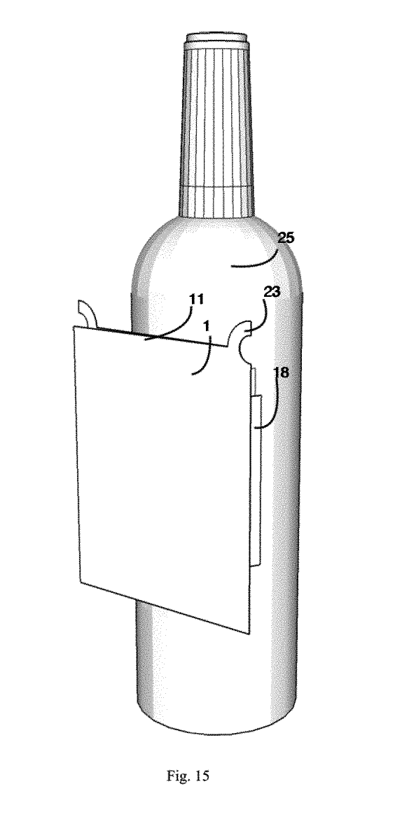

FIG. 16 is a perspective view which shows the side of a folded bottle card with a central panel display curve on a gift bottle.

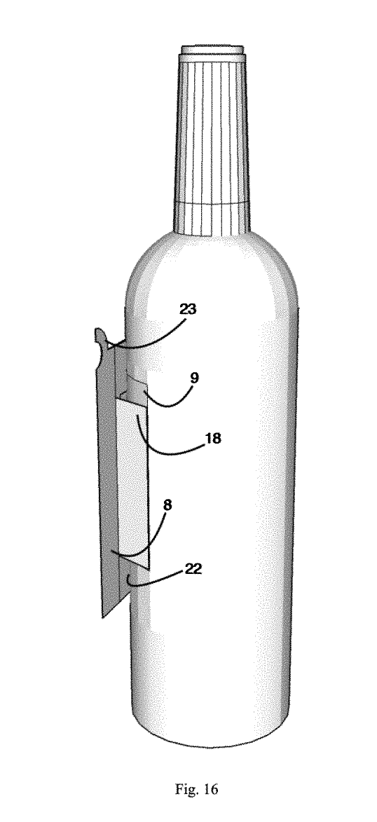

FIG. 17 is a perspective view which shows a delayed reveal embodiment where two bottle cards are created as a template for later adornment and features in the open position.

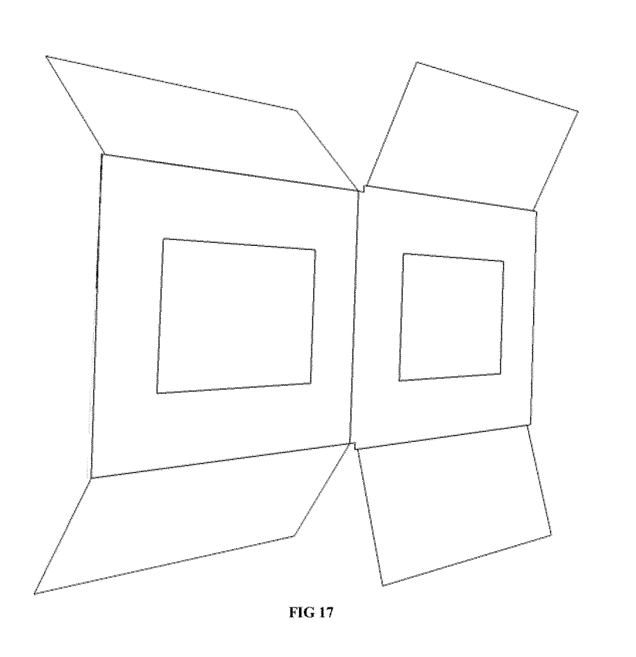

FIG. 18 is a perspective view which shows a delayed reveal embodiment where two bottle cards are created as a template for later adornment and features in the folded position.

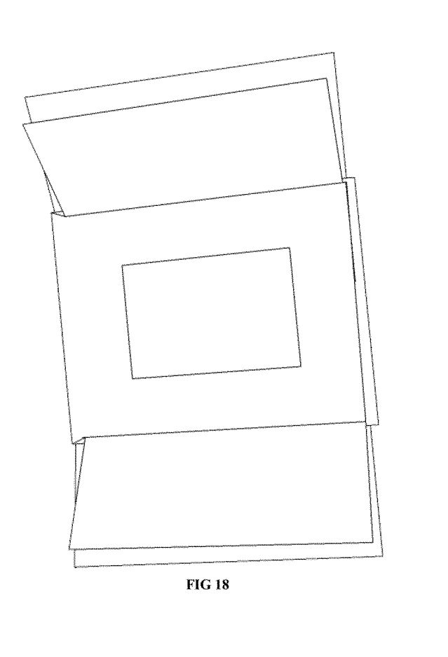

### DETAILED DESCRIPTION OF THE INVENTION

A preferred embodiment of the present invention is now described with reference to the figures, where like reference numbers indicate identical or functionally similar elements. A person of ordinary skill in the relevant art will recognize that other configurations and arrangements can be used without departing from the spirit and scope of the invention. It will be apparent to a person of ordinary skill in the relevant art that this invention can also be employed in a variety of other systems and applications.

In a preferred use of the instance invention, overall, a person first makes a bottle card 24 (Step 101). Spatially, the bottle card 24 is preferably positioned on a gift bottle 25. The bottle card 24 comprises a greeting card designed to attach to a bottle and reveal a bottle label 22 through the unfolding of one or more bottle card panels 16. In some embodiments, a bottle card 24 preferably comprises bottle card popups, one or more panel brace 23, two or more bottle card panels, and one or more bottle card adornments.

The bottle card 24 has an alternative embodiment herein termed the ‘delayed reveal’ embodiment. The ‘delayed reveal’ embodiment comprises an embodiment wherein one or more bottle card are connected to one another by a dorsal central panel edge 40 or a ventral central panel edge 41, serving as a template wherein die cuts or ornamentation can be planned and implemented on these additional surfaces.

The ‘delayed reveal’ embodiment allows one to add a panel from which the media can be displayed. Additionally, the ‘delayed reveal’ embodiment allows one to have additional panels for ornamentation that can be cut, allowing an overall template to be used rather than having specific design for each card. Further, the ‘delayed reveal’ embodiment allows one to create a two or more ply card increasing the amount of cut and ornamental options for a designer.

Further, the ‘delayed reveal’ embodiment has additional panels to delay the reveal of the bottle label, wherein the reveal is delayed in proportion to the number of the bottle card panels otherwise affixed via the dorsal central panel edge 40 or a ventral central panel edge 41. Further, the ‘delayed reveal’ embodiment creates additional folds for means by which additional popups can be powered.

A panel brace 23 comprises a component when articulated prevents one or more panels from returning to a closed position. In some embodiments, it is thought that an example of a panel brace 23 could be cut out braces that span between two panels or perhaps additive braces that span between two panels and the like. In other embodiments, instead of articulation, panel brace 23 may prevent one or more panels from returning to a closed position, through different materials, designs and the like.

In making a bottle card, next, a person decides on a general shape, and/or bottle card adornments 10 and/or popups (Step 201). The bottle card popups 17 comprise adornment portions of the bottle card 24 attached to one or more bottle card panels 16 that actuate when manipulated by a person. The bottle card adornments 10 comprise one or more ornamental displays attached to one or more of bottle card 24 panel or bottle card popups 17. In some embodiments, it is thought that examples of bottle card adornments may include: labels, texts, indicia, flaps, box layers, v-fold lifters, rotaters, an asymmetrical v-fold pivot, a symmetrical v-fold pivot, electronics, sound effects, or LEDS.

In some embodiments, there may be a delayed reveal, by adding one or more bottle cards operably attached to serve as a template. If a person wanted to a build a ‘delayed reveal’ embodiment (Step 202) they decide on the number of bottle card 24 (Step 203). Then, for each bottle card 24 attached, a person decides the size of each connected bottle card 24 (Step 204) that would be connected by either a dorsal central panel edge or a ventral central panel edge 41.

A dorsal central panel edge 40 (FIGS-dorsal central panel edge 40) comprises the edge on top of the central panel, which in some embodiments operably attaches to one or more additional bottle card 24 ventral central panel edge 41 and may form a fold where in one or more bottle cards may fold onto one another, such as in the ‘delayed reveal’ embodiment.

A ventral central panel edge 41 comprises the edge on bottom of the central panel, which in some embodiments operably attaches to one or more additional bottle card 24 dorsal central panel edge 40 and may form a fold where in one or more bottle cards may fold onto one another, such as in the ‘delayed reveal’ embodiment .

Next, a person decides if they would like to have images on one or more additional connected bottle card 24 (Step 205). If a person has images (Step 206), then, a person decides on the placement, position, size and other customizable attributes of the images on one or more panels (Step 207).

If a person would like the modification to the border of one or more images (Step 208) and if a person would like one or more panels to be die cut (Step 209) and if a person would like to add a border stroke (Step 210), then, one or more border stroke can be designated as planned to occur (Step 211) and one or more die cut can be designated planned to occur (Step 212).

If a person would like one or more panels to be die cut (Step 209) and the person would not like a border stroke (Step 213), then, one or more die cut can be designated planned to occur (Step 214).

If a person would like modification to the border of one or more images (Step 208) and a person would like to add a border stroke without die cut (Step 215), then, one or more border stroke can be designated as planned to occur (Step 216).

If a person decides on the placement, position, size and other customizable attributes of the images on one or more panels (Step 207) and does not want the images modified (Step 217), then proceed to Step 220.

Then, if a person decides they would like to have images on one or more additional connected bottle card 24 (Step 205) but the person does not have images (Step 218), then, a person chooses from stock images (Step 219).

After deciding on images, a person decides if they would like to have text. If, a person would like to have text (Step 221), then, a person decides on the placement, position, size, text, color and other customizable attributes of the text on one or more bottle card panels (Step 222).

If a person does not have text (Step 223), then, a person does not have to add text (Step 224).

Next, a person makes a bottle card flap system 8 (Step 225). The bottle card flap system 8 comprises a system for display management that allows for differential curvature parameters to be ascertained and designed. The bottle card flap system 8 allows for adhesion of the bottle card 24 to the gift bottle 25. In some embodiments, the bottle card flap system 8 preferably comprises bottle card flaps, at least one flap angle edge 19, and at least one bottle angling span 14.

Next, in a preferred embodiment, a person identifies each of the three bottle card panels 16 (Step 301). The bottle card panels 16 comprise the panels of the card that form the structural functionality for adherence and revealing the bottle label 22. In some embodiments, the bottle card panels 16 preferably comprise a lateral interior panel 12, a lateral exterior panel 11, and finally a central panel 21. The bottle card panels 16 may also have an alternative embodiment herein termed the ‘two panel’ embodiment.

After identifying each of the three bottle card panels, preferably, a person cuts the central window 20 into the central panel 21 (Step 302). Spatially, the central panel 21 is preferably positioned in between the lateral exterior panel 11 and the lateral interior panel 12. The central panel 21 comprises the middle panel that surrounds the label and operably attaches to the gift bottle 25. In some embodiments, the central panel 21 is preferably comprised of a central window 20, a central panel interior face 7, a bottle card flap system 8, a dorsal central panel edge 40, a ventral central panel edge 41 and finally a central panel exterior face 6.

Spatially, the central window 20 is preferably positioned in the central region of the central panel 21. The central window 20 comprises the cutout portion of the central panel 21 that is used to display the label. In addition, the central window 20 preferably comprises the lateral window edge 15. The central panel exterior face 6 comprises the portion of the central panel 21 used to display one or more bottle card popups 17 and/or bottle card adornments 10. The central panel interior face 7 comprises the face of the central panel that contacts the bottle.

In some embodiments, after cutting the central window 20 into the central panel, a person decides on the bottle angling span 14 (Step 303). The bottle angling span 14 comprises the region of the bottle card flap system 8 that is dependent upon the span from the lateral window edge 15 to the flap angle edge 19. The bottle angle span determines the display parameters of the bottle card 24. In some embodiments, it is thought that if the bottle angling span 14 is absent then one may adhere the card without a span.

If a person wants to have a bottle card 24 with a large curvature and more contact (Step 304) then the person chooses a large angling span (Step 305). If the person wants to have a bottle card 24 with a minimal curvature and little contact (Step 306) then the person chooses a smaller or no angling span (Step 307).

Next, in order to create bottle card flap system, a person folds on the lateral window edge. (Step 308). The lateral window edge 15 comprises the lateral edge of the central window 20 that is folded in order to create the bottle card flap system 8.

Next, a person folds on the flap angle edge 19 (Step 309). The flap angle edge 19 comprises the edge opposite of the lateral window edge 15 that when folded on the perforation creates the bottle card flaps 18. Next, a person binds the interior of the angling span to the back of the central panel interior face 7 (Step 310).

Then a person creating the bottle card may complete the adornments or popups (Step 203) and prepare the bottle card 24 for packaging (Step 204). One or more person may then distribute the bottle card 24 to one or more retail stores (Step 102).

Preferably, at a retail store a person (consumer) would first identify a gift bottle 25 for a bottle card (Step 103). A gift bottle 25 is preferably cylindrical in shape, however, it is thought that in alternative embodiments that it may also be flatly shaped like a box. The gift bottle 25 comprises an item that carried and delivered by a human hand. In some embodiments, it is thought that examples of a gift bottle 25 may include: wine bottles, a vinegar bottle, flower vases, olive oil bottles, beer bottles, champagne bottles, spice bottles, cider bottles, or a bottles of potable liquid. In some embodiments, a gift bottle 25 preferably comprises bottle adhesion regions, a label center midline 13, and finally a bottle label 22.

Next, a person identifies a bottle card 24 they would like to place on the gift bottle 25 (Step 104). After selecting a bottle card, a person opens the bottle card package (Step 105). Then a person may personalize the gift bottle 25 with a written note, art, drawings, or other ornamental designs. In some embodiments, this personalization mechanism may operably attach to the bottle card (Step 106).

Next, a person prepares the bottle card 24 (Step 107) and opens the bottle card flaps 18 (Step 401). The bottle card flaps 18 comprise the articulating flaps that rotate, unfold and which may attach to the bottle, formed from the central panel 21. The bottle card flaps 18 preferably comprise the bottle card adhesion system 5. In some embodiments, a person then removes the adhesive cover (as part of the bottle card adhesion system 5) on each bottle card flap 18 (Step 402).

The bottle card adhesion system 5 comprises a means for adhering the bottle card flaps 18 to the gift bottle 25. In some embodiments, it is thought that examples of a bottle card adhesion system 5 may include: tape, glue, or double-sided tape and the like.

Overall, a person then adheres the bottle card 24 to the gift bottle 25 (Step 108). In some embodiments, this may occur by orientating both the lateral interior panel 12 and the lateral exterior panel 11 in order to create a line of site for positioning (Step 501). Spatially, the lateral exterior panel 11 is preferably positioned over the lateral interior panel 12. The lateral exterior panel 11 comprises a fold for covering the window and/or housing adornments which may comprise additional sub-panels or perforations that is preferably outside the lateral interior panel 12. The lateral exterior panel 11 preferably comprises the lateral exterior panel external face 1 and the lateral exterior panel internal face 4. In some embodiments, it is thought that if the lateral exterior panel 11 is absent then a two panel embodiment may suffice. Spatially, the lateral interior panel 12 is preferably positioned under the lateral exterior panel 11.

The lateral interior panel 12 comprises a fold for covering the window and/or housing adornments which may comprise additional sub-panels or perforations that is preferably inside the lateral exterior panel 11. In some embodiments, it is thought that if the lateral interior panel 12 is absent then a two panel embodiment may suffice. The lateral interior panel 12 preferably comprises the lateral interior panel external face 3 and the lateral interior panel internal face 2.

The lateral interior panel external face 3 comprises the external portion of the lateral interior panel used to display one or more bottle card popups 17 and/or bottle card adornments 10.

The lateral interior panel internal face 2 comprises the internal portion of the lateral interior panel used to display one or more bottle card popups 17 and/or bottle card adornments 10.

In some embodiments, after orientating both the lateral interior panel 12 and the lateral exterior panel 11 in order to create a line of site for positioning, a person positions the bottle card flaps 18 on opposite sides of the label center midline 13 of the bottle label 22 (Step 502). In some embodiments, the bottle label 22 is mainly thought to be composed of paper, however other embodiments may be composed of any of the following: paint, plastic, vinyl, sand blasted into the material, or carved into the material. The bottle label 22 comprises a material adhered to the gift bottle 25 that identifies the contents or brand associated with the gift bottle 25. If the bottle label 22 is absent, it is thought that that there are alternatives. For example, if absent then a label may be inherent in the structure of the bottle. Further, it is possible that in its absence then the bottle card 24 may be used without a label. Finally, if absent then a card board cylinder surrounding the gift bottle 25 may be the substrate for displaying the bottle card 24. The label center midline 13 comprises the part of the bottle label 22 that is designed to be the central focus for a consumer.

In some embodiments, after positioning, next, a person adheres the bottle card flaps 18 to the gift bottle 25 via the bottle card adhesion system 5 to one or more bottle adhesion regions 9 (Step 503) and closes the panels. The bottle adhesion regions 9 comprise the regions of the bottle wherein the adhesive binds.

Once a person receives the gift bottle and card (Step 109), the receiver opens one or more panels to display the bottle label 22 (Step 110). In some embodiments, a person may articulate one or more panel brace 23 in order to maintain the panels in an open state (Step 111).

1. I claim a system for card creation comprising:
a gift bottle, wherein said gift bottle comprises a gift with a cylindrical shape that can be carried and delivered by a human hand;
a bottle card, wherein said bottle card comprises a greeting card designed to attach to a bottle and reveal a bottle label through the unfolding of one or more bottle card panels.
